(19) United States
(12) Patent Application Publication
(10) Pub. No.: US 2005/0008466 A1
(43) Pub. Date: Jan. 13, 2005

(54) Loading floor with slant for a vehicle and a loading apparatus

(75) Inventors: Nick Albrecht, Isenbuttel (DE); Thoma Wulf, Gifhorn (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(73) Assignee: SAI AUTOMOTIBE SAL GmbH, Hagenbach (DE)

(21) Appl. No.: 10/731,887

(22) Filed: Dec. 8, 2003

Related U.S. Application Data
(63) Continuation of application No. PCT/EP03/05352, filed on May 22, 2003.

(30) Foreign Application Priority Data
May 23, 2002 (DE) 102 22 967.8

(51) Int. Cl. B60P 1/00

(52) U.S. Cl. 414/522

(57) ABSTRACT

A loading apparatus for a vehicle in which a loading floor is provisioned in a loading area of the vehicle, with elements for lifting the loading floor over a loading edge. The elements for lifting exhibit a slant, provisioned on the loading floor, for supporting the loading floor on the loading edge during lifting. Guide linkages or guide channels are provided for the loading floor.

### RELATED APPLICATION

This application is a continuation of International Application PCT/EP03/05352 filed May 22, 2003, the contents of which are here incorporated by reference in their entirety.

### BACKGROUND OF THE INVENTION

1. Field of the Invention

The invention relates to a loading apparatus for a vehicle, and more particularly to a loading floor for a vehicle.

2. Prior Art

Various pull-out loading floors and loading apparatuses are known from the state of the art. A pull-out loading surface for station wagons is known from DE-OS 23 972, wherein guide rails are provisioned on the loading surface of the vehicle. The pull-out loading surface is mounted on these guide rails and can be moved on the guide rails on rollers. The items to be loaded can then be set onto the pulled out loading surface and pushed into the loading area of the vehicle.

A loading apparatus for personal vehicles or transportation vehicles is known from DE 296 08 955 U1. This loading apparatus consists of a guide element that is mounted on the floor of the loading area of the vehicle. A movable loading plate is located on the guide element and can be moved from a transportation position inside the loading area into a loading or unloading position, in which the loading plate is located outside of the vehicle, behind the rear of the vehicle.

A loading apparatus on an automobile with a swinging rear hatch is known from DE 196 19 126 A1. Fastened guide rails that run along the length of the vehicle are provisioned on both sides of the floor of the rear loading area, which can be closed by the rear hatch of the vehicle, Loading requires that the rear hatch is moved to the back into a horizontal loading position along a lower axis that runs traverse to the vehicle.

A loading floor for the loading area of a vehicle is known from DE 197 49 158 C2. The loading floor is mounted on rollers so that it can be moved, and can be partially pulled out of the loading area approximately parallel to the vehicle. The loading floor exhibits a crumple zone, provisioned traverse to the length of the car, in order to improve crash behavior.

A pull-out loading floor for a vehicle is known from DE 197 31 324 A1, which can be moved by means of rollers along support rails. The support rails are connected to the vehicle body such that their height can be adjusted. The height adjustment occurs by means of two parallelogram steering devices, with the help of an adjustment cylinder.

A further loading floor is known from U.S. Pat. No. 3,132,755, which can be pulled out of the loading area on guide rails approximately parallel to the vehicle floor. Further state of the art is know from DE 100 54 572 A1, DE 198 15 466 A1, DE 41 28 008 A1, DE 100 12 767 A1 and DE 298 10 132 U.

Pull-out loading floors and loading apparatuses of the type mentioned allow for simplified loading and unloading of the vehicle by setting the freight on the rolling loading floor. A load placed onto the pulled out loading floor can be pushed, along with the loading floor, into the interior of the vehicle without requiring much force. However, a common disadvantage of the previously known loading floors and loading apparatuses is that, due to the design of the pull-out mechanism for the loading floor, a considerable amount of loading area is lost. A further disadvantage is the large construction costs required for such known loading floors and loading apparatuses.

### SUMMARY OF THE INVENTION

The object of the invention is therefore to provide an improved loading apparatus for a vehicle.

The object of the invention is achieved by the characteristics of the preferred embodiments that will be described hereinafter in detail and the teachings hereof.

A particular advantage of the invention is that the usable loading area is substantially maintained and only decreased minimally by the loading floor and the corresponding loading apparatus. A further advantage is that a loading apparatus, according to the invention, can be realized with only a small number of construction elements. Such an apparatus can therefore be produced inexpensively and is simultaneously especially reliable.

The slant is configured on the face of the loading floor that lies across from the loading edge in the pushed-in state of the loading floor. When the loading floor is lifted, this slant moves diagonally upwards, whereby the loading floor supports itself on the loading edge with its slant. Roll or slide elements are provisioned between the slant and the loading edge that are used when lifting. For example, a roller is provisioned on the loading edge that the loading edge runs over the lifted. Roll or slide elements provisioned on the slant of the loading floor facilitate the movement of the loading floor along the slant and reduce friction. The roll or slide elements also facilitate the horizontal movement of the loading floor out of the loading area of the vehicle by reducing the friction between the lower side of the loading floor and the upper side of the loading edge. It is particularly advantageous if these roll or slide elements are provisioned on the upper edge of the loading edge that lies across from the slant of the loading floor in its pushed-in state. In this case the same roll or slide elements are effective during the lifting of the loading floor, as well as during the horizontal outwards movement of the loading floor.

According to a further preferable embodiment form of the invention, the loading floor is carried by a spacing element that lies on the side of the loading floor across from the rear bench of the vehicle, where the lower end of the spacing element engages the guide linkage. The guide linkage is provisioned running lengthwise underneath the loading floor, for example on the sidewalls of the vehicle or on the vehicle floor. The lower end of the spacing element moves through the guide linkage in the pulling-out or pushing-in directions to move the loading floor in or out of the loading area, while the other end of the loading floor moves first upwards, due to the slant moving along the loading edge, and then horizontally out of the loading area over the loading edge.

According to a preferable embodiment form of the invention, the guide linkage or channel has a first section that runs parallel to the slant and a second section that runs horizontally. To extend of retract the loading floor, the lower end of the spacing element is first moved along the first section of the guide linkage, which runs diagonally upwards, while the other end of the loading floor moves along a parallel path on the slant of the loading edge.

The length of the first section of the guide linkage is such that as soon as the lower end of the spacing element has reached its end, the end region of the loading floor has reached the upper end of the loading edge. Due to this, the loading floor is lifted upwards in a diagonal direction and is simultaneously moved a distance in the pull-out, or push-out respectively, direction. It is preferable that the loading floor remains horizontal throughout this process, that is, it should remain parallel to the vehicle floor.

After this diagonal upwards motion, the lower end of the spacing element runs along the second section of the guide linkage, runs horizontally. In the process the lower side of the loading floor slides over the loading edge, so that the loading floor is moved out of the loading area horizontally.

According to a further preferable embodiment form of the invention, the spacing element consists of steering devices provisioned on the loading floor, which hold a shaft and on the ends of which roll or slide elements are located. The ends of the shaft engage the guide linkage. Driving force is transferred to the shaft by, for example, a toothed belt or V-belt, which lifts the loading floor.

According to a further preferable embodiment form of the invention, the drive mechanism is provisioned on the body of the vehicle or on the lower side of the loading floor. The driving force is transferred from the drive mechanism to the shaft by a toothed belt or V-belt on a steering roller, which exerts pressure on the belt to keep it taught. Alternatively, a chain can also be used for the transmission. The drive mechanism can be a mechanical, electric, pneumatic or hydraulic drive.

According to a further preferable embodiment form of the invention, guide elements for guiding the inwards and/or outwards movement of the loading floor along the slant are located on the end region of the loading floor and/or on the loading edge. There are, for example, one or multiple recesses in the slant provisioned on the loading floor, which are engaged by corresponding elements provisioned on the loading edge.

According to a further preferable embodiment form if the invention, roll or slide elements are provisioned on the side walls of the loading area to guide the inwards or outwards movement of the loading floor, and in particular to prevent that the loading floor becomes skewed while moving. For example, spring-loaded slide elements are provisioned on the sidewalls along the extension/retraction movement path of the loading floor.

### BRIEF DESCRIPTION OF THE DRAWINGS

Further, preferred embodiments of the invention will, with consideration for the drawings, be explained in more detail. In the drawings:

FIG. 1 shows a side-view of the loading area of a vehicle with a preferred embodiment form of a loading apparatus according to the invention.

FIG. 2 shows a cross-sectional view of the loading area from FIG. 1 in the region of the loading edge.

FIG. 3 shows a cross-sectional view of the loading area from FIG. 1 in the region of the guide linkage.

FIG. 4 shows an embodiment of a drive mechanism.

FIG. 5 shows a detailed view of the drive mechanism shown in FIG. 4.

### DETAILED DESCRIPTION OF PREFERRED EMBODIMENTS OF THE INVENTION

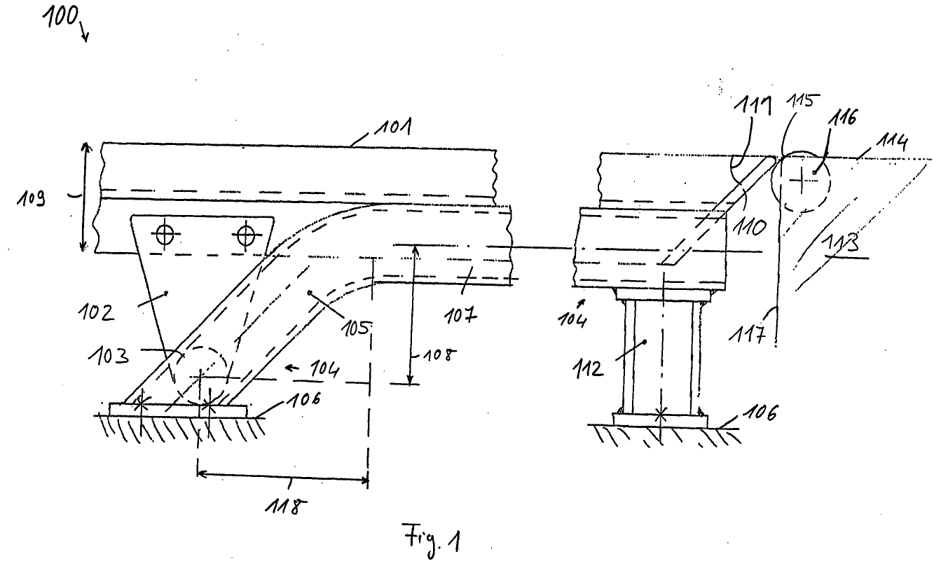

FIG. 1 shows loading apparatus 100 installed or provisioned in the loading area of an automobile. The automobile is preferably an automobile with a rear hatch.

Loading apparatus 100 has loading floor 101, which can be extended out of the loading area. Loading floor 101 has a spacing element at its end, which is across from the rear seats of the automobile. This spacing element consists of steering devices 102, which are provisioned on both sides of loading floor 101. Drive rollers 103 are located on steering devices 102 and engage guide linkage 104. Guide linkages or channels 104 are, for example, provisioned in the two sidewalls of the vehicle. Section 105 of the guide linkage extends diagonally upwards from vehicle floor 106.

Horizontally running section 107 of the guide linkage connects to section 105 of guide linkage 104. Section 105 of guide linkage 104 serves to lift loading floor 101 distance 108, which corresponds approximately to thickness 109 of loading floor 101 (drawing not to scale).

Loading floor 101 has slant 110 at its other end, which forms angle 111 with the upper side of loading floor 101. The angle preferably measures between 25° and 60°, preferably 45°.

Horizontally running section 107 of the guide linkage is carried by support 112, which is provisioned on vehicle floor 106.

The loading area is bordered by loading edge 113 at the rear of the vehicle. When loading floor 101 is in its retracted state, the upper side of loading floor 101 and upper side 114 of loading edge 113 form a flat loading surface. At least one slide ball 116 is provisioned in the region of edge 115 formed by loading edge 113.

The slide ball extends somewhat above upper side 114 of loading edge 113, as well as above side 117 of loading edge 113. Slide ball 116 serves to facilitate the lifting of loading floor 101, as well as to facilitate the horizontal extension of loading floor 101. The same applies for the retraction or lowering of the loading floor.

Driving force is exerted on loading floor 101 to extend loading floor 101 out of the position shown in FIG. 1. This can occur through manual force in that, for example, a grip provisioned on the upper side of loading floor 101 is pulled. The driving force can, however, also be provided by a mechanical, electric, pneumatic or hydraulic drive mechanism.

Drive rollers 103 are moved through sections 105 of guide linkage 104 due to the driving force. Slant 110 simultaneously moves over slide ball 116.

When drive rollers 103 have reached the ends of sections 105 of guide linkage 104, loading floor 101 has been lifted distance 108 and has simultaneously moved distance 118 horizontally in the extension direction.

In this position, loading floor 101 is located at approximately the elevation of upper side 114 of loading edge 113 and lies on slide ball 116.

Drive rollers 103 are further moved through sections 107 of guide linkage 104, so that loading floor 101 is extended horizontally out of the loading area of the vehicle. In this process, the lower side of loading floor 101 runs over slide ball 116. It is especially advantageous here that slide ball 116 is effective both during the lifting of the loading floor and during the horizontal extension of the loading floor.

Loading floor 101 can then be conveniently loaded while it is in the extended position. After loading, loading floor 101 can be pushed back into the loading area, along with its load. This does not require any great effort, since drive rollers 103 move back into the retracted position due to the force of gravity exerted along section 105 of guide linkage 104. Retraction of loading floor 101 can alternatively be effected through a drive mechanism.

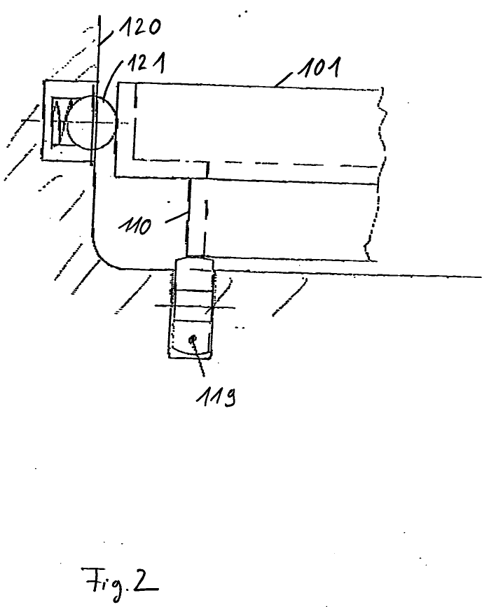

FIG. 2 shows a cross-section of FIG. 1, where roller 119 is provisioned in place of slide ball 116. Slide balls 121, which prevent that loading floor 101 becomes skewed as it is extended or retracted, are provisioned in sidewalls 120 of the vehicle along the path of the movement of loading floor 101. Alternatively, spring-loaded sliders or other guide elements can also be provisioned.

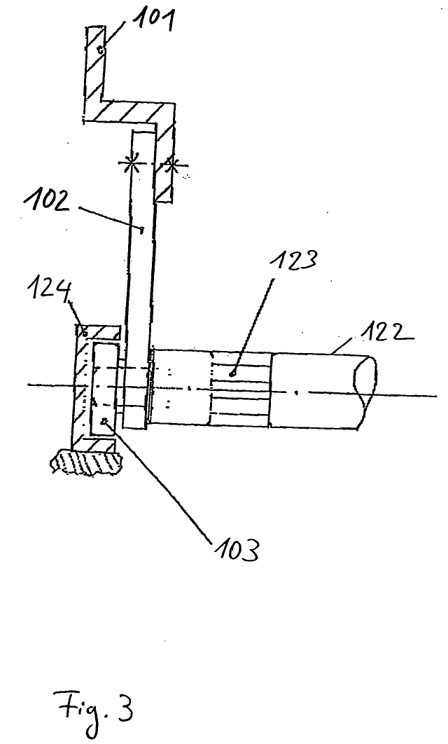

FIG. 3 shows a cross-sectional view in the region of steering devices 102. Shaft 122, on which gear wheel 123 is located, is held by steering devices 102. A V-belt disk or something similar can also be used in place of gear wheel 123.

Drive rollers 103 are provisioned at the end of shaft 122. The drive rollers engage U-profile 124, which forms guide linkage 104. When drive force is applied to gear wheel 123 it is transferred to drive rollers 103 by means of shaft 122, so that drive rollers 103 move through U-profile 124. This moves loading floor 101 inwards or outwards, according to the direction of the driving force.

Drive rollers 103 can each be equipped with one gear wheel, which engages a corresponding toothed profile in the running surface of U-profile 124, for a positive transfer of force to U-profile 124.

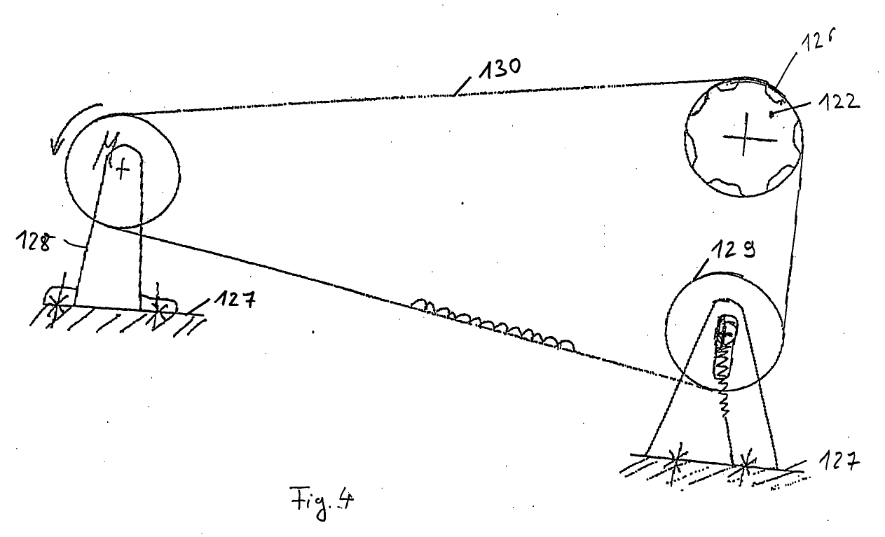

FIG. 4 shows an apparatus for driving shaft 122 (compare with FIG. 3). The apparatus consists of drive mechanism 128, fastened to body 127 of the vehicle, and steering roller 129. Toothed belt 130 runs along drive mechanism 128, steering roller 129 and shaft 122, or gear wheel 123 located on shaft 122, respectively. The driving force exerted on toothed belt 130 by drive mechanism 128 is transferred to shaft 122 in order to drive rollers 103 in U-profile 124, so that loading floor 101 is moved outwards or inwards, according to the direction of the driving force.

It is preferable that steering roller 129 is provisioned spring-loaded on body 127, in order to keep toothed belt 130 taut. A V-belt can also be used in place of a toothed belt.

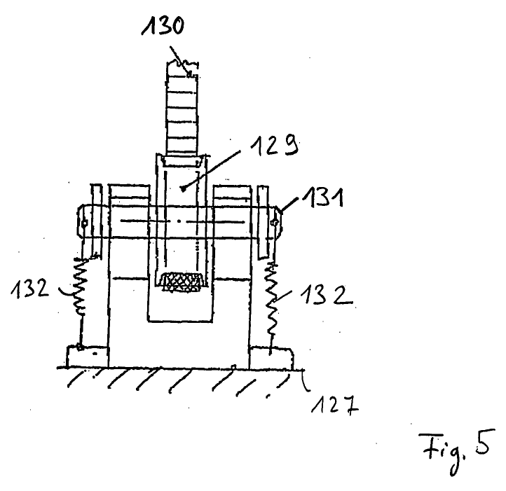

FIG. 5 shows a cross-sectional view of steering roller 129, which is provisioned on axle 131. Force is exerted on the end regions of axle 131 in the direction of body 127 by pulling elements 132. Toothed belt 130, which runs over steering roller 129, is thus kept taut.

Legend Loading apparatus 100

Loading floor 101

Steering device 102

Drive roller 103

Guide linkage 104

Section 105

Vehicle floor 106

Section 107

Distance 108

Thickness 109

Slant 110

Angle 111

Support 112

Loading edge 113

Upper side 114

Edge 115

Slide ball 116

Side 117

Distance 118

Roller 119

Side wall 120

Slide ball 121

Shaft 122

Gear wheel 123

U-profile 124

Body 127

Drive mechanism 128

Steering roller 129

Toothed belt 130

Axle 131

Pulling element 132

1. Loading apparatus for a vehicle, with loading floor provisioned in a loading area of the vehicle with elements for lifting the loading floor over loading edge, wherein the elements for lifting exhibit slant for supporting the loading floor on the loading edge during lifting, and with guide linkage for the loading floor, wherein a roll or slide element is provisioned in the region of a loading edge, and wherein the roll or slide element is effective both when lifting loading floor and when loading floor is moved horizontally relative to the loading area of the vehicle.

2. Loading apparatus according to claim 1, wherein the roll or slide element is provisioned on the loading edge, where slide ball or roller is driven over when the loading floor is lifted and during the horizontal movement of the loading floor.

3. Loading apparatus according to claim 1, wherein the slant is provisioned on the face of the loading floor that lies across from the loading edge in the retracted state.

4. Loading apparatus according to claim 1, wherein the guide linkage is provisioned along the lengthwise-running sides of the loading area and is configured with a spacing element provisioned at the first end region of the loading floor, which is configured for engaging the guide linkage.

5. Loading apparatus according to claim 1, wherein a drive mechanism is provisioned on one of the body of the vehicle and the lower side of the loading floor for driving the loading floor into or out of the loading area of the vehicle.

6. Loading apparatus according to claim 1, wherein the spacing element exhibits steering devices, provisioned on the side walls of the loading floor, where a shaft is held by the steering devices, and where drive elements engage the guide linkage.

7. Loading apparatus according to claim 1, wherein elements are provisioned for steering a toothed belt or V-belt, and for keeping it taut.
